(19) United States
(12) Patent Application Publication
(10) Pub. No.: US 2025/0261040 A1
(43) Pub. Date: Aug. 14, 2025

(54) METHOD AND APPARATUS FOR HANDLING ACCESS TRAFFIC OVER MULTIPLE ACCESS PATHS

(71) Applicant: Huawei Technologies Co., Ltd., Shenzhen (CN)

(72) Inventors: Zhixian Xiang, Frisco, TX (US); Abbas Kiani, Vieanna, VA (US); Kaippallimalil Mathew John, Carrollton, TX (US); Khosrow Tony Saboorian, Frisco, TX (US)

(21) Appl. No.: 19/193,494

(22) Filed: Apr. 29, 2025

Related U.S. Application Data
(63) Continuation of application No. PCT/US2023/036495, filed on Oct. 31, 2023.
(60) Provisional application No. 63/421,350, filed on Nov. 1, 2022.

(51) Int. Cl. H04W 28/08

(52) U.S. Cl. CPC H04W 28/0858

(57) ABSTRACT

Various aspects of the present disclosure generally relate to wireless communication. In some aspects, a first network function device receives an access traffic rule for a multi-access protocol data unit (MA PDU) session of a user equipment (UE) from a second network function device, where the access traffic rule defines information on how to handle a traffic flow associated with the MA PDU session over multiple data paths corresponding to different access networks. The first network function device receives network performance data related to the access traffic rule from a third network function device and performs access traffic controlling of the traffic flow over the multiple data paths in accordance with the access traffic rule and the network performance data.

### PRIORITY CLAIM AND CROSS-REFERENCE

This patent application is a continuation of PCT Application No. PCT/US2023/036495, filed on Oct. 31, 2023 and entitled “Method and Apparatus for Handling Access Traffic Over Multiple Access Paths,” which claims the benefit of U.S. Provisional Application No. 63/421,350, filed on Nov. 1, 2022 and entitled “Enhancement of Rule and Policy for Using Multi-Access & Multi-Data-Path to Steer, Switch and Split URLLC Traffic,” applications of which are hereby incorporated by reference herein as if reproduced in their entireties.

### TECHNICAL FIELD

The present disclosure relates generally to methods and systems for splitting wireless traffic from a single device to utilize multiple networks and/or access technologies.

### BACKGROUND

More and more mobile devices are capable of establishing sessions with a communication network using different radio access technologies (e.g., 5^{th} generation (5G), 4G, WiFi, Satellite). It is becoming feasible for connecting a mobile device through different networks (e.g., private network, public network) to improve quality of service (QoS) for reliability and latency.

### SUMMARY

In accordance with an embodiment, a method for access traffic controlling includes receiving, by a first network function device from a second network function device, an access traffic rule for a multi-access protocol data unit (MA PDU) session of a user equipment (UE), wherein the access traffic rule defines information on how to handle a traffic flow associated with the MA PDU session over multiple data paths corresponding to different access networks. The method also includes receiving, by the first network function device from a third network function device, network performance data related to the access traffic rule. The method also includes performing, by the first network function device, access traffic controlling of the traffic flow over the multiple data paths in accordance with the access traffic rule and the network performance data.

In an embodiment, the access traffic rule is an access traffic steering, switching, and splitting (ATSSS) rule. In an embodiment, the different access networks comprise a first 3rd Generation Partnership Project (3GPP) access network and a second 3GPP access network. In an embodiment, the first network function device is a user plane function (UPF) device, the second network function device is a policy configuration function (PCF) device or a home network device, and the third network function device is a network data analytic function (NWDAF) device. In an embodiment, the ATSSS rule comprises ATSSS rule timer information indicating a periodic interval which the ATSSS rule needs to be checked and executed; and the method further includes setting, by the first network function device, an ATSSS rule timer in accordance with the ATSSS rule timer information. In an embodiment, the ATSSS rule includes at least one of the following: access type information indicating an access type of an access network, network type information indicating a network type of a network which the ATSSS rule will be applied, or network identifier information indicating an identifier of a network associated with the ATSSS rule. In an embodiment, the method further includes sending, by the first network function device to the UE, an ATSSS indication indicating an ATSSS capability supported by at least one of the different access networks. In an embodiment, the ATSSS rule comprises at least one of a dual access connectivity time restriction or a dual access connectivity location restriction. In an embodiment, the ATSSS rule includes at least one of the following: a location-based steer mode in which a traffic controlling decision is made based on a location of the UE or based on a predicted UE location; a time-based steer mode in which different traffic control rules are provided for use based on different time windows; a customized-performance-based steer mode in which a traffic controlling decision is made based on a home operator who owns a subscription of the UE, can define its own performance criteria defined by a home operator who own a subscription of the UE; or an ultra reliable low latency communication (URLLC) steer mode for URLLC traffic in which a traffic controlling decision is made based on a performance metric of combining a delay and reliability. In an embodiment, the method further includes obtaining, by the first network function device, at least one of statistics information or prediction information and sending, by the first network function device, the at least one of the statistics information or the prediction information to the UE for UE uplink traffic controlling over the multiple data paths corresponding to the different access networks.

In accordance with an embodiment, a method performed by a UE, includes establishing, by the UE, a MA PDU session with a first network function device over multiple data paths corresponding to different access networks. The method also includes receiving, by the UE from a second network function device, an access traffic controlling rule that defines information as how to handle a traffic flow for the MA PDU session over the multiple data paths corresponding to the different access networks. The method also includes receiving, by the UE, performance data related to the access traffic controlling rule. The method also includes transmitting, by the UE, traffic data of the traffic flow over the multiple data paths in accordance with the access traffic controlling rule and the performance data.

In an embodiment, the access traffic rule is an ATSSS rule. In an embodiment, the different access networks comprise a first 3GPP access network and a second 3GPP access network. In an embodiment, the first network function device is a user plane function (UPF) device, the second network function device is a policy configuration function (PCF) device or a home network device. In an embodiment, the ATSSS rule includes ATSSS rule timer information indicating a periodic interval which the ATSSS rule needs to be checked and executed, and the method further includes setting, by the UE, an ATSSS rule timer in accordance with the ATSSS rule timer information. In an embodiment, the ATSSS rule includes at least one of the following: access type information indicating an access type of an access network, network type information indicating a network type of a network which the ATSSS rule will be applied, or network identifier information indicating an identifier of a network associated with the ATSSS rule. In an embodiment, the method further includes receiving, by the UE, an ATSSS indication indicating an ATSSS capability supported by at least one of the different access networks. In an embodiment, the ATSSS rule includes at least one of a dual access connectivity time restriction or a dual access connectivity location restriction. In an embodiment, the ATSSS rule includes at least one of the following: a location-based steer mode in which a traffic controlling decision is made based on a location of the UE or based on a predicted UE location; a time-based steer mode in which different traffic control rules are provided for use based on different time windows; a customized-performance-based steer mode in which a traffic controlling decision is made based on a home operator who owns a subscription of the UE, can define its own performance criteria defined by a home operator who own a subscription of the UE; or a URLLC steer mode for URLLC traffic in which a traffic controlling decision is made based on a performance metric of combining a delay and reliability. In an embodiment, the method further includes receiving, by the UE, at least one of statistics information or prediction information used for controlling the traffic flow over multiple data paths corresponding to different access networks. In an embodiment, the at least one of statistics information or prediction information is received from a third network function device via the first network function device.

In accordance with an embodiment, a communication system, includes a first network function device, a second network function device and a third network function device. The second network function device is configured to maintain one or more access traffic rules. The third network function device is configured to maintain network performance data related to the one or more access rules. The first network function device is configured to establish a MA PDU session with a UE, receive an access traffic rule for the MA PDU session from the second network function device, wherein the access traffic rule defines information on how to handle a traffic flow associated with the MA PDU session over multiple data paths corresponding to different access networks, receive first network performance data related to the access traffic rule from a third network function device, and perform access traffic controlling of the traffic flow over the multiple data paths in accordance with the access traffic rule and the first network performance data related to the access traffic rule.

In accordance with an embodiment, an apparatus includes at least one processor; and a non-transitory memory storing programming instructions that, when executed by the at least one processor, cause the system to perform any of the methods described above.

In accordance with an embodiment, a non-transitory computer readable storage medium includes instructions that when executed by a processor cause the processor to perform any of the methods described above.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless communications network;

FIG. 2 illustrates an example 5G architecture 200 for ATSSS support in accordance with an embodiment;

FIG. 3 is a diagram illustrating ATSSS functionality implementation in a UE in accordance with an embodiment;

FIG. 4 is a diagram of a system illustrating ATSSS between two 3GPP networks for an exemplary use case in accordance with an embodiment;

FIG. 5 is a diagram of an exemplary network in which the disclosed methods and systems for MA ATSSS may be implemented;

FIG. 6 is a message flow diagram illustrating a method for multi-access and multi-data-path to steer, switch and split URLLC traffic in accordance with a disclosed embodiment;

FIG. 7 is a flowchart illustrating an exemplary method in a UE for performing multi access traffic splitting in accordance with a disclosed embodiment;

FIG. 8 is a flowchart illustrating an exemplary method in a UPF for performing multi access traffic splitting in accordance with a disclosed embodiment;

FIG. 9 illustrates an example communication system;

FIGS. 10A and 10B illustrate example devices that may implement the methods and teachings according to this disclosure; and

FIG. 11 is a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Various embodiments of communication systems will now be presented with reference to various apparatuses and methods. These apparatuses and methods will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Disclosed embodiments enhance 5th generation (5G) access traffic steering, switching, splitting rule/policy to support more flexible network deployment for ultra reliable low latency communication (URLLC) service and allow traffic being split/steered/switched between different 5G access technologies and networks. URLLC supports use cases that require high network reliability, more than 99.999%, and extremely low latency of approximately 1 millisecond for data transmission. For example, autonomous driving would require a connection capable of this, as there is such high risk involved. Autonomous driving has a whole host of benefits, from timesaving to improving safety by eliminating user error. However, it would need all vehicles to be connected to each other vehicle-to-vehicle, and to roadside systems, vehicle-to-infrastructure, such as traffic light systems, emergency services and road maintenance programs. Data would need to be shared in real-time, with minimal latency, as safety requirements demand ultra-reliable connections. URLLC offers an interesting proposition for the Internet of Things (IoT).

Disclosed herein are methods, systems, and apparatus for using Multi-Access & Multi-Data-Path to steer, switch and split URLLC traffic according to rules/policies and, in some embodiment, performance data. Some aspects of the disclosure refer to a method performed by a network function device, component, or unit for a multi-access protocol data unit (PDU) session over multiple data paths via different access networks. The first network function device may receive (e.g. a User Plane Function (UPF) device) an access traffic rule (e.g. an access traffic steering, switching, and splitting (ATSSS) rule/policy) from a second network function device (e.g. a Policy Configuration Function (PCF) device) and receive or query performance data related to the access traffic rule from a third network function device (e.g. NetWork Data Analytic function (NWDAF) device). The first network function device may perform access traffic controlling of the traffic flow over the multiple data paths in accordance with the access traffic rule and the network performance data. The access traffic controlling may be downlink traffic controlling of the traffic flow, which might include at least one of steering, switching or splitting of the traffic flow over the multiple data paths or links.

In various embodiments, the terms of “ATSSS rule” and “ATSSS policy” may be used interchangeably, whenever appropriate. In ATSSS, “steering” refers to the possibility of selecting for user-plane traffic, according to a service (e.g. QoS-type for a data flow), the best link or data paths to use, “switching” describes the possibility of performing handover without service interruption to the other link when necessary, “splitting” means the simultaneous use (bonding) of the links or data paths. The various aspects of method and apparatus can be applied to URLLC traffic, such that the traffic controlling based on access traffic rule (e.g. ATSSS rule) and performance data is optimal for URLLC traffic, thereby effectively ensuring E2E QoS (End-to-End quality of service). In various aspects of method and apparatus, all sorts of factors or parameters may be considered for access traffic controlling, for example the E2E roundtrip delay between multiple data paths or links, ATSSS rule, ATSSS decision criteria, comprehensive QoS measurement as a decision input, flexible deployments. More details will be described later.

Some embodiments of the disclosure provide a method performed by a UE for a MA PDU session over multiple data paths (or links). The UE may connect to a first network function (e.g. UPF) device over a first data path (or link) via a first network and connect to the first network function device over a second data path (or link) via a second network, where the first network may correspond to at least one of a first radio access technology (RAT), a first 3GPP network type, or a network identifier (ID), and the second network may correspond to at least one of a second RAT, a second 3GPP network type, or a second network ID. The first connection between the UE and the first network function device via the first data path and the second connection between the UE and the second network function device are associated to the MA PDU session. The UE may receive an access traffic rule (e.g. ATSSS rule) from a second network function (e.g. PCF) device, and receive performance data related to the access traffic rule. The UE may transmit traffic data of the service flow across the first data path and the second data path according to the access traffic rule and the performance date. The ATSSS rule defines information as how to at least one of steer, switch, or split traffic between the first data path and the second data path.

Some embodiments of the disclosure provide an apparatus comprising at least one processor and a non-transitory memory storing programming instructions that, when executed by the at least one processor, cause the system to perform the method performed by the UE or any network function device.

Some embodiments of the disclosure provide a non-transitory computer readable storage medium including instructions that when executed by a processor cause the processor to perform the method performed by the UE or any network function device.

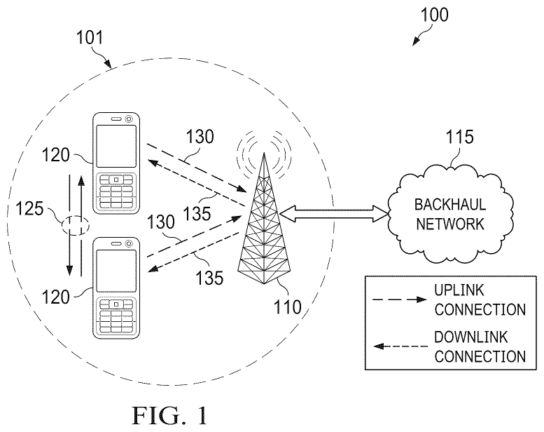

FIG. 1 illustrates an example communications system 100, according to embodiments. Communications system 100 includes an access node 110 serving UEs with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1, the sidelink communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless access technologies, which may be Third Generation Partnership Project (3GPP) wireless access technologies and non-3GPP wireless access technologies. The 3GPP wireless access technologies may include long term evolution (LTE), LTE advanced (LTE-A), 5^{th} generation (5G), 5G New Radio (NR), sixth generation (6G), High Speed Packet Access (HSPA). The non-3GPP wireless access technologies may include WiFi access technologies defined by the IEEE 802.11 family of standards, such as 802.11a/b/g/n/ac/ad/ax/ay/be, etc., satellite access technologies. While it is understood that communications systems may employ multiple access nodes capable of communicating with a number of UEs, only one access node and two UEs are illustrated for simplicity.

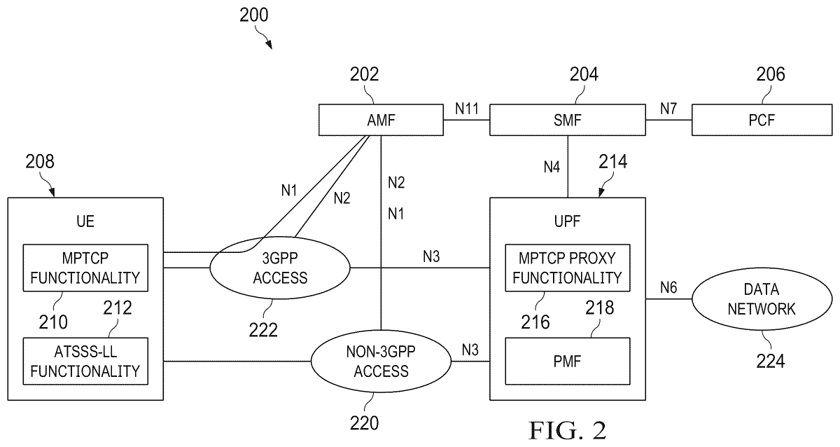

FIG. 2 illustrates an example 5G architecture 200 for ATSSS support in accordance with an embodiment. Architecture 200 includes a UE 208, a UPF214, a data network 242, an Access Management Function (AMF) 202, a Session Management Function (SMF) 204, and a PCF 206. The UPF 214, AMF 202, SMF 204, and PCF 206 may be implemented within the same or different physical network components, the network components including data processing systems. The UE 208 includes Multi-Path Transmission Control Protocol (MPTCP) functionality 210 and ATSSS-LL functionality 212. The UPF 214 includes MPTCP proxy functionality 216 and a Performance Management Function (PMF) 218. The UE 208 may communicate with the data network 224 through the UPF 214 via 3GPP access 222 and non-3GPP access 220. The AMF 202 communicates with the SMF 204 which communicates with the PCF 206. The UE 208 may communicate with the AMF 202 via the 3GPP access 222 and/or the non-3GPP access 220. The UPF 214 communicates with the SMF 204. The activities and functions of the various functions 202, 204, 206, 214 are described in more detail below.

In 3GPP Radio Access Network (RAN) working groups, the multi-path concept refers to different radio transmission paths. In contrast, multi-path in this application is from a 5G core network perspective. Multi-path means that there may be different paths or links established via different access networks for a service in a UE so the traffic of that service may be split and steered between those different paths or links. A 5G feature which supports this multipath steer/switch/split is called ATSSS, which was developed in 3GPP SA2 since release 16. This feature enables a multi-access (MA) PDU Connectivity Service, which can exchange PDUs between the UE and a data network by concurrently using one 3GPP access network and one non-3GPP access network and two independent N3/N9 tunnels between the PSA and RAN/AN. The multi-access PDU Connectivity Service is realized by establishing a Multi-Access PDU (MA PDU) Session, i.e., a PDU Session that may have user-plane resources on two or more access networks. FIG. 2 shows the 5G network architecture for ATSSS support (non-roaming case using N3).

The functionality in an ATSSS-capable UE that can steer, switch, and split the MA PDU Session traffic across 3GPP access and non-3GPP access, is called a “steering functionality”. The UPF in the network can also implement this steering functionality for downlink traffic, e.g., within the MPTCP proxy functionality module. There are two levels of steering functionality:

High-layer steering functionalities, which operate above the Internet Protocol (IP) layer

Low-layer steering functionalities, which operate below the IP layer

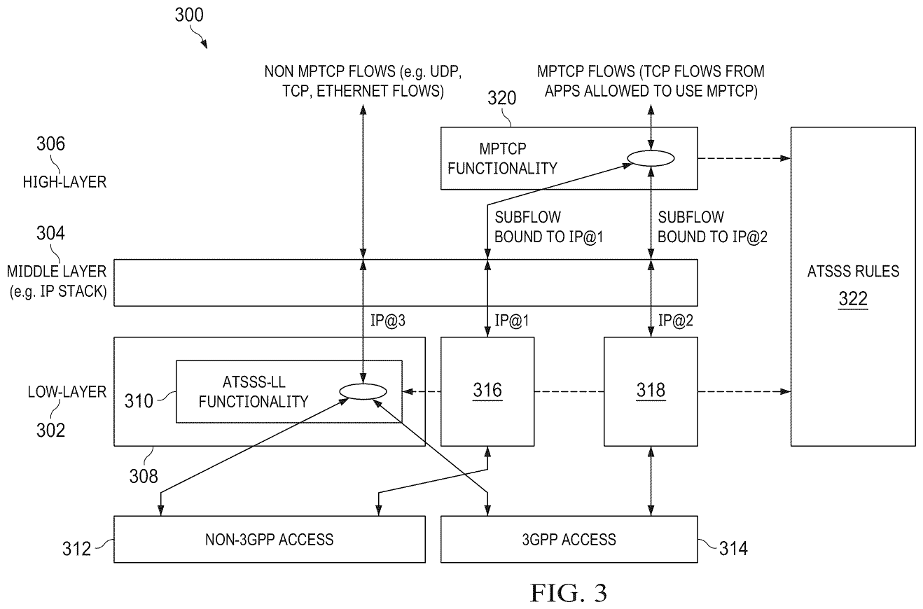

FIG. 3 is a diagram illustrating ATSSS functionality 300 implementation in a UE in accordance with an embodiment. The ATSSS functionality 300 in the UE includes a low-layer 302, a middle-layer 304 (e.g., an IP stack), and a high-layer 306. The low-layer 302 includes non-3GPP access 312 and 3GPP access 314 as well as IP access 308, 316, 318. The low-layer 302 may include ATSSS Low Layer (LL) functionality 310. The high-layer 306 includes MPTCP functionality 320 which controls MPTCP flows (TCP flows from applications allowed to use MPTCP). Other non-MPTCP flows (e.g., User Datagram Protocol (UDP), TCP, ethernet flows) flow from the ATSSS LL functionality 310 via the middle layer 304 by passing the MPTCP functionality 320. ATSSS rules 322 are applied to the ATSSS-LL functionality 310 and to the MPTCP functionality 320.

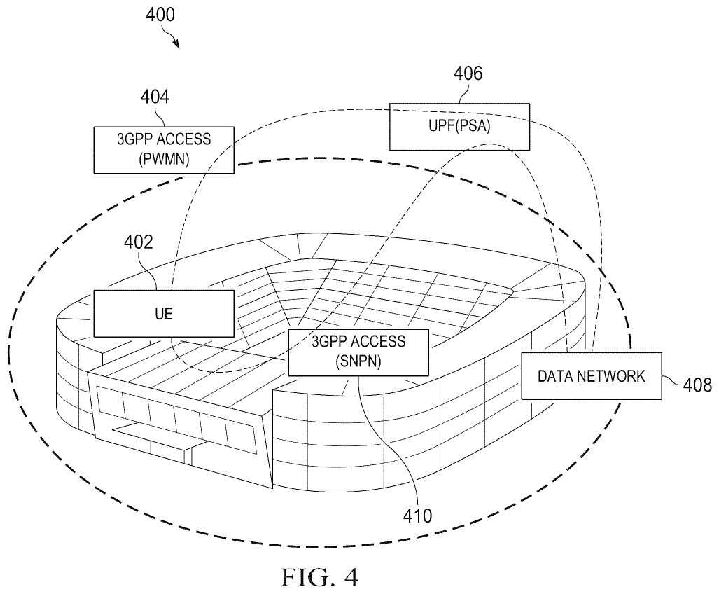

FIG. 4 is a diagram of a system 400 illustrating ATSSS between two 3GPP networks for an exemplary use case in accordance with an embodiment. System 400 includes a UE 402, 3GPP access 404 via a Public Land Mobile Network (PLMN), 3GPP access 410 via a Stand-alone Non-Public Network (SNPN), a UPF (PSA) 406, and a data network 408. The UE 402 splits its uplink PDU traffic to the data network 408 into two flows with one flow traversing through 3GPP 404 and one flow traversing through 3GPP 410. Downlink traffic from the data network 408 to the UE 402 is split by the UPF (PSA) 406 into two flows with one flow flowing through the 3GPP access 404 and one flow flowing through the 3GPP access 410. The uplink and downlink traffic is split according to ATSSS rules. The 3GPP access points 404, 410 may use the same or different 3GPP Radio Access Technologies (RATs) (e.g., 5G New Radio (NR) or Non-Terrestrial Networks (NTN), plus one of NR, NTN or Long Term Evolution (LTE)). Note, NTN refers to NR-based satellite access, including different orbits (e.g., Geostationary Orbit (GEO)/Medium Earth Orbit (MEO)/Low Earth Orbit (LEO)).

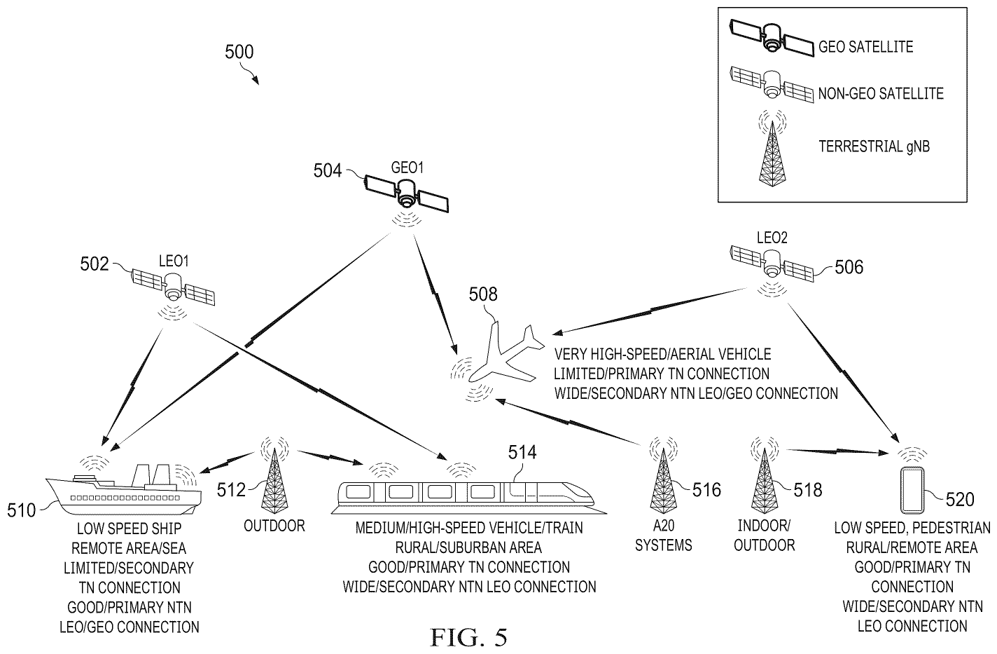

FIG. 5 is a diagram of an exemplary network 500 in which the disclosed methods and systems for MA ATSSS may be implemented. Network 500 is a combination of a 5G satellite network and a 5G group network. Network 500 includes LEO satellites 502, 506 and a GEO satellite 504. The network 500 also includes fixed position terrestrial gNBs 512, 516, 518 and mobile terrestrial gNBs 510 located on, for example, a low-speed ship, mobile terrestrial gNB 514 located, for example, on a medium to high speed vehicle, such as a train, and mobile terrestrial gNB 508 located on, for example, a very high-speed aerial vehicle. Mobile terrestrial gNB 510 may be located in a remote area and may have limited or secondary terrestrial network (TN) connectivity with good or primary NTN LEO/GEO connection.

Mobile terrestrial gNB 514 may be located in a rural or suburban area and have good/primary TN connectivity and wide/secondary NTN LEO connectivity. Mobile terrestrial gNB 508 may have limited/primary TN connectivity and wide/secondary NTN LEO/GEO connectivity. Fixed position terrestrial gNB 518 may be indoor or outdoor. Fixed position terrestrial gNB 516 may be a 2G system. Network 500 may also include a UE 520 that may have low speed mobility, such as a pedestrian and may be located in a rural or remote area with good/primary TN connectivity and wide/secondary NTN LEO connectivity.

In some embodiments, the access traffic rule like ATSSS rule may include information in table 1. Part or all information in the table 1 can be received after the MA session between the UE and UPF is established.

Referring to Table 1, access type descriptor indicates access type which includes different 3GPP RATs (such as 4G/5G, satellite access, different spectrum bands, so on), or different network type, or different network which is identified by a network ID in a ATSSS rule to allow ATSSS rules being applied to particular 3GPP access type.

TABLE 1
Structure of ATSSS Rule

| | | | SMF | |
|---|---|---|---|---|
| | | | permitted to | |
| Information | | | modify in a | |
| name | Description | Category | PDU context | Scope |
| Rule | Unique identifier to identify the | Mandatory | No | PDU |
| identifier | ATSSS Rule | | | context |
| Rule | Determines the order in which | Mandatory | Yes | PDU |
| Precedence | the ATSSS rule is evaluated in | (NOTE 1) | | context |
| | the UE. | | | |
| Access type | Define the different RAT access | Mandatory | | PDU |
| descriptor | types which the rule will be | | | context |
| | applied to: | | | |
| | 1. 3GPP RAT: 4G, 5G, | | | |
| | 3GPP based satellite, | | | |
| | different spectrum | | | |
| | 2. Non-3GPP RAT: wifi, | | | |
| | Bluetooth, non-3gpp | | | |
| | satellite | | | |
| Network type | Define the different network | Optional | | PDU |
| | types which the rule will be | | | context |
| | applied to: NPN, PLMN | | | |
| Network ID | The identifiers of the network | Optional | | PDU |
| | associated with this rule | | | context |
| Traffic | This part defines the Traffic | Mandatory | | |
| Descriptor | descriptor components for the | (NOTE 2) | | |
| | ATSSS rule. | | | |
| Application | One or more application | Optional | Yes | PDU |
| descriptors | identities that identify the | | | context |
| | application(s) generating the | | | |
| | traffic (NOTE 3). | | | |
| IP descriptors | One or more 5-tuples that | Optional | Yes | PDU |
| (NOTE 4) | identify the destination of IP | | | context |
| | traffic. | | | |
| Non-IP | One or more descriptors that | Optional | Yes | PDU |
| descriptors | identify the destination of non-IP | | | context |
| (NOTE 4) | traffic, i.e. of Ethernet traffic. | | | |
| Access | This part defines the Access | Mandatory | | |
| Selection | Selection Descriptor components | | | |
| Descriptor | for the ATSSS rule. | | | |
| Steering | Identifies the steering mode that | Mandatory | Yes | PDU |
| Mode | should be applied for the | | | context |
| | matching traffic and associated | | | |
| | parameters. | | | |
| Steering | Indicates either autonomous | Optional | Yes | PDU |
| Mode | load-balance operation or UE- | (NOTE 6) | | context |
| Indicator | assistance operation if steering | | | |
| | mode is set to “Load Balancing”. | | | |
| Threshold | A Maximum RTT and/or a | Optional | Yes | PDU |
| Values | Maximum Packet Loss Rate. | (NOTE 6) | | context |
| Steering | Identifies whether the MPTCP | Optional | Yes | PDU |
| Functionality | functionality or the ATSSS-LL | (NOTE 5) | | context |
| | functionality should be applied | | | |
| | for the matching traffic. | | | |
| ATSSS rule | Periodic interval which the rule | Optional | Yes | PDU |
| timer | needs to be checked and | | | context |
| | executed. | | | |

(NOTE 1):
Each ATSSS rule has a different precedence value from the other ATSSS rules.
(NOTE 2):
At least one of the Traffic Descriptor components is present.
(NOTE 3):
An application identity consists of an OSId and an OSAppId.
(NOTE 4):
An ATSSS rule cannot contain both IP descriptors and Non-IP descriptors.
(NOTE 5):
If the UE supports only one Steering Functionality, this component is omitted.
(NOTE 6):
The Steering Mode Indicator and the Threshold Values shall not be provided together.

Some embodiments may be implemented as part of Access Selection descriptor as defined in 3GPP TS23.501, to associate each steering traffic model with certain 3GPP access types or network. e.g.
1. For the Active-standby steering mode: As defined in the current standard specification, it is used to steer an SDF on one access (the Active access), when this access is available, and to switch the SDF to another available access (the Standby access), when the Active access becomes unavailable. Only two access types are supported in current standard specifications (non-3GPP access and 3GPP access). An embodiment is to extend the existing policy by adding more access types, network types and network IDs, e.g., indicating which 3GPP access type, or 3GPP network type (PLMN or NPN) or 3GPP network (identified by network ID) is to be active access or standby access.
2. For the Smallest Delay steering model: It is used to steer an SDF to the access that is determined to have the smallest Round-Trip Time (RTT). An embodiment is to extend the existing policy by adding more 3GPP access types, 3GPP network types, or 3GPP networks (identified by network IDs), each of which can be associated with specific delay threshold and steer policy. For example, a new steering policy for SDF, which will steer between 5G ground RAN and 5G satellite RAN depending on which network has the smallest delay, but the maximum RTT threshold for steering the SDF to satellite RAN is when satellite network's RTT measurement is smaller than is, otherwise the SDF will be kept in 5G ground RAN.
3. For the load-balancing steering mode: It is used to split an SDF across both accesses if both accesses are available. It contains the percentage of the SDF traffic that should be sent over 3GPP access and over non-3GPP access. An embodiment is introduced to add traffic percentage policy for available 3GPP access types, or network types or networks identified by the network ID. For example, a new policy describes that for a SDF, 80% traffic needs to be transported in PLMN 1, while the remaining 20% traffic needs to be transported in SNPN 2.
4. For the Priority-based steering mode: It is used to steer all the traffic of an SDF to the high priority access, until this access is determined to be congested. In this case, the traffic of the SDF is sent also to the low priority access, i.e. the SDF traffic is split over the two accesses. An embodiment is introduced to add a new policy to define priority between different 3GPP RAT accesses, between different network types (PLMN vs NPN) or between different networks, and how to split and steer a specific service data flow (SDF) between those RAT accesses and networks. For example, defining a new policy in which 5G RAN has higher priority than 4G RAN for a video SDF. When 5G RAN is congested, the UE and the UPF will split 70% traffic of a SDF to be conveyed in the 5G RAN, while 30% traffic being conveyed in the 4G RAN.

In some embodiments, the ATSSS rule may include a decision interval which the ATSSS rule enforcer, such as UE, UPF, SMF, will periodically check the communication conditions which are defined in the ATSSS rules and make an ATSSS decision at each interval. This would enhance some traffic like the URLLC traffic.

In some embodiments, one or more new items may be included in the ATSSS rule/policy to allow UE to steer/switch/split uplink traffic into different access type networks or different networks based on more specific network performance, such as the RAN performance which UE can measure, such as signal to noise ratio (SNR), in order to quickly react to connection condition changes and guarantee the QoS requirement for the URLLC traffics. The SNR can be the statistical summary of the uplink (UL) SNR of the UE during a monitor period or the predict using artificial intelligence (AI) and/or machine learning (ML).

In some embodiments, the UE's moving trajectory (getting closer to one access network while getting away from another) can also impact the UE's connection performance. For some use cases, the UE's travel path is relative fixed and predicable, so the ATSSS rule can be created and executed based on UE's mobility behavior. For example, the ATSSS rule can be based on the UE's location, so when the UE reaches a certain location (cell, tracking Area, or Geographic location), the UE applies certain ATSSS rule or steering model. An embodiment is introduced to add UE mobility behavior or location as policy for ATSSS rule. One example is to create a new steer mode based on UE location: when the UE is in certain cell, tracking area or coverage of certain network, the UE uses that network/cell as a higher priority network, and applies the traffic ratio for the traffic split between this network and other access network.

Besides the existing 4 steer modes which have been defined in the standard (Active-Standby, Smallest Delay, Load-Balancing, Priority-based), an embodiment introduces new steer modes and their corresponding ATSSS rule in order to meet new deployment demands:
1. URLLC steer mode for URLLC traffic: In this steer mode, ATSSS decision is made based on a performance metric of combining delay level (smallest delay) and reliability level (Highest reliability, e.g. lowest Packet Lost Rate). In this mode, UE and UPF will split the traffic and steer most of data traffic to the network with lowest latency and highest reliability as highest priority network, and steer the rest of traffic to another network with second lowest delay and second highest reliability. The other option to rank the combine performance metric is to use weight/scale factor associated with each metric and calculate the total performance score. E.g., A*X+B*Y. X represents one metric (delay) and Y represents another metric (reliability). A can be scalar/weight such as 1 and B can be another weight/scalar such as 10. The network with the highest score of this combined performance metrics will have the highest priority with higher traffic split ratio. The network can be a different access type network, a different deployment type of network (PLMN or NPN), or a different network being operated by a different operator. In this steer mode, the interval of checking the ATSSS rule with latest connection performance data and executing the ATSSS rule is defined. With this interval, UE and Network periodically checking network performance against the ATSSS rule to make sure traffic can always be transported in the best network, e.g., the UE and Network create a timer for the interval. When the timer expires, the UE and network execute the ATSSS rules and reset the timer.
2. Customized-performance-based steer mode: which the home operator, who owns the subscription of the UE, can define its own performance criteria to trigger the UE to change the traffic steering/switching/split action between different networks. Examples of this performance criteria can be radio signaling thresholds, bandwidth allocation by the network, backhaul or fronthaul throughput or congestion level threshold.
3. Location-based steer mode: In this steer mode, the UE or UPF makes ATSSS decisions based on the UE's location (cell, tracking area or geographic location, within one network's coverage (by reading network ID)) or the predicted moving trajectory to use a different traffic split/switch/splitting policy. One example implementation is a new ATSSS rule defining that when a UE is in coverage of cell #4 of network A and also in cell #2 of network B, the UE and UPF will split 60% of its video traffic to network A while 40% traffic to network B.
4. Time-based steer mode: In this steer mode, some network deployments may manage the operation based on the time, e.g., some networks may reduce resources for operation because of energy efficiency considerations. In this mode, the UE or UPF will use different traffic steer/switch/split rule based on the time of the day, or different time window. For this mode, the ATSSS rule defines different traffic ATSSS policy for different periods with start and end time, or different lengths of the time window as the validity of the rule (e.g., a ATSSS rule only can last 2 hours then fall back to the default ATSSS rule or another designated rule).

Some embodiments contain an extension of the existing ATSSS rule for smallest delay steer mode to add a new policy to allow the UE and network to split the data traffic associated with the MA PDU session and steer them between the two or more data paths via two different networks with defining traffic split ratio between those two or more data paths. The existing standard only allows traffic being switched between two or more data paths for smallest delay steer mode.

Some embodiments contain a new indication provided by the network (via broadcast or in the control message exchanged with UE) whether it can support ATSSS functionality, which includes what access type network, steer mode it can support.

Some embodiments contain some validity conditions of applying the ATSSS rule. UE or Network function can apply the ATSSS rules if the validity conditions are met. The conditions can include the location, time or QoS performance association with the network.

In some embodiments, network wide holistic data analytic input may be considered for the decision of creating and execute the ATSSS rule. An embodiment is introduced to bring network analytic functionality into the ATSSS policy creation and execution process, including several implementation options:
1. Option 1: Create a new analytic identifier (ID) for ATSSS policy and decision making. Therefore, there can be a new dedicated ATSSS Data analytic output from NWDAF associated with this analytic ID. This new ATSSS data analytic output can be used for various ATSSS operations:
   a. For dynamic ATSSS policy creation, NWDAF can provide analysis on the previous experience or future prediction of the experience on the data steering/switching/splitting between different 5G access/network type for particular SDF(s), Therefore, the PCF or any policy making function (e.g., SMF) which creates the ATSSS rules/policy will update the ATSSS rule/policy accordingly and send the updated policy to UPF or UE.
   The data analytic output for ATSSS policy creation can include: statistics data or prediction on the latency, PLR, throughput of the SDF using different steering modes; the overall network performance measurement for those access type networks, or networks which are using the ATSSS rule; the UE or user mobility behavior which is related to ATSSS (e.g. moving pattern around base station, leaving or closer to RAN, so on).
   b. For real time ATSSS execution to support URLLC traffic. A new ATSSS data analytic output from NWDAF can provide holistic network and UE connectivity performance information, including the historic statistics and performance prediction(s) associated with certain ATSSS policy. The UE or UPF can use the analytic output as performance measurement information against the ATSSS rule/policy they receive and execute the policy. The PMF can also use this analytic output as one of the inputs for its measurement managements and provide the final measurement result to UE or UPF for ATSSS execution.
   The data analytic output for ATSSS execution may include statistics data or prediction on the connectivity and resource performance measurements for different access types, network types or networks which are used in ATSSS. The measurement can include, e.g., RAN radio interface KPIs (SNR, congestion level), available bandwidth allocated by the network in both radio interface and backhaul, N3 and backhaul congestion level, so on.
2. Option 2: Extending existing analytic IDs defined in TS23.288 to include some new parameters for ATSSS, which UE, SMF or PCF can collect the information from NWDAF, then make comprehensive split/steer/switch policies. The UE and UPF can also use the information from NWDAF for ATSSS decision based on those policies. The potential existing analytics, which are identified by different analytic IDs and can be enhanced for ATSSS work, are:
   a. UE mobility Analytic: It is to collect UE mobility related information from NF, OAM and perform data analytics to provide UE mobility statistics or predictions. An embodiment introduces new output information on the UE mobility between two different 3GPP RAT access networks or two 3GPP networks which are defined in ATSSS rule. The network functions and UE which are involved in ATSSS can use the location and mobility information to act accordingly, e.g., the Network or UE may steer more traffic to the access network which UE is moving into and steer less traffic to the network which UE is moving away from. This location information can include:
      i. statistics or predicted information on the percentage of UEs connecting to each access network
      ii. Statistics or predicted information on the UE's distance to the base station in each access network.
   b. UE Communication Analytic: its data analytics on UE communication pattern and user plane traffic and provide the analytics results (i.e. UE communication statistics or prediction) to NFs in the 5GC. An embodiment introduces new input and output information on the UE's communication from which ATSSS rule/policy is applied. The example of input information can be introduced as illustrated below based on Tables 2.

TABLE 2
Service Data from 5G Core (5GC) related to UE communication

| Information | Source | Description |
|---|---|---|
| UE ID (Identifier) | SMF, AF | SUPI in the case of SMF, external UE ID (i.e. GPSI) in the |
| | | case of AF |
| Group ID (Identifier) | SMF, AF | To identify UE group if available |
| | | Internal Group ID in the case of SMF, External Group ID in |
| | | the case of AF |
| S-NSSAI | SMF | Information to identify a Network Slice |
| DNN | SMF | Data Network Name where PDU connectivity service is |
| | | provided |
| Application ID | SMF, AF | Identifying the application providing this information |
| (Identifier) | | |
| Expected UE | AF | Same as Expected UE Behaviour parameters specified in |
| Behaviour | | TS 23.502 [3] |
| parameters | | |
| UE communication | UPF, AF | Communication description per application |
| (1 . . . max) | | |
| >Communication | | The time stamp that this communication starts |
| start | | |
| >Communication | | The time stamp that this communication stops |
| stop | | |
| >UL data rate | | UL data rate of this communication |
| >DL data rate | | DL data rate of this communication |
| >Traffic volume | | Traffic volume of this communication |
| Type Allocation code | AMF | To indicate the terminal model and vendor information of the |
| (TAC) | | UE. The UEs with the same TAC may have similar |
| | | communication behaviour. The UE whose communication |
| | | behaviour is unlike other UEs with the same TAC may be an |
| | | abnormal one. |
| UE locations | AMF | UE positions |
| (1 . . . max) | | |
| >UE location | | TA or cells that the UE enters |
| >Timestamp | | A time stamp when the AMF detects the UE enters this |
| | | location |
| UE location trends | AMF | Metrics on UE locations. |
| PDU Session ID | SMF | Identification of PDU Session. |
| (1 . . . max) | | |
| >N4 Session ID | SMF, | Identification of N4 Session. |
| | UPF | |
| >Inactivity detection | SMF, | Value of session inactivity timer. |
| time | UPF | |
| >PDU Session status | SMF | Status of the PDU Session (activated, deactivated). |
| UE CM state | AMF | UE connection management state (e.g. CM-IDLE). |
| UE session behaviour | SMF | Metrics on UE state transitions (e.g. “PDU Session |
| trends | | Establishment”, “PDU Session Release”). |
| UE communication | SMF | Metrics on UE communications. |
| trends | | |
| UE access behaviour | AMF | Metrics on UE state transitions (e.g. access, RM and CM |
| trends | | states, handover). |
| UE ATSSS | UPF, | Communication description per each access network or 3GPP |
| communication | SMF, | network which defined in the ATSSS rule |
| | PMF | |
| >ATSSS rule time | | The period of one ATSSS rule is executed and monitored |
| duration | | |
| >Latency | | Latency of this communication |
| >Packet lost rate | | Packet lost Rate of this communication |
| >Traffic volume | | Traffic volume of this communication |
| >ATSSS mode | | Indicate if traffic is split and steered to, or is switched to this |
| | | access network. |
| >Other QoS metrics | | |

The NWDAF supporting UE Communication Analytics provides the analytics results to consumer NFs (e.g. SMF, AF, UE or UPF). The analytics results provided by the NWDAF include the UE communication statistics as defined in Table 3 or predictions as defined in Table 4.

TABLE 3
UE Communication Statistics

| Information | Description |
|---|---|
| UE group ID or UE ID | Identifies a UE or a group of UEs, e.g. internal group ID |
| | defined in TS 23.501 [2] clause 5.9.7 or SUPI (see |
| | NOTE). |
| UE communications (1 . . . max) | List of communication time slots. |
| (NOTE 1) | |
| >Periodic communication | Identifies whether the UE communicates periodically or |
| indicator (NOTE 1) | not. |
| >Periodic time (NOTE 1) | Interval Time of periodic communication (average and |
| | variance) if periodic. |
| | Example: every hour |
| >Start time (NOTE 1) | Start time observed (average and variance) |
| >Duration (NOTE 1) | Duration of communication (average and variance). |
| >Traffic characterization | S-NSSAI, DNN, ports, other useful information. |
| >Traffic volume (NOTE 1) | Volume UL/DL (average and variance). |
| >Ratio | Percentage of UEs in the group (in the case of a UE |
| | group). |
| Applications (0 . . . max) | List of application in use. |
| (NOTE 1) | |
| >Application Id | Identification of the application. |
| >Start time | Start time of the application. |
| >Duration time | Duration interval time of the application. |
| >Occurrence ratio | Proportion for the application used by the UE during |
| | requested period. |
| >Spatial validity | Area where the service behaviour applies. If Area of |
| | Interest information was provided in the request or |
| | subscription, spatial validity may be a subset of the |
| | requested Area of Interest. |
| ATSSS communication | Per SDF which ATSSS rule is applied to |
| >SDF ID | |
| >ratio of ATSSS | Percentage of traffic volume being steered/switched/split |
| | between 2 access networks |
| >Duration | Duration of time which traffic being steered/switch/split |
| | between 2 access networks |
| >Latency | Overall average latency |
| >Packet lost rate | Overall PLR |
| >Other QoS/QoE | |
| information | |
| N4 Session ID (1 . . . max) | Identification of N4 Session. |
| (NOTE 1) | |
| >Inactivity detection time | Value of session inactivity timer (average and variance). |

(NOTE 1):
Analytics subset that can be used in “list of analytics subsets that are requested” and “Preferred level of accuracy per analytics subset”.

TABLE 4
UE Communication Predictions

| Information | Description |
|---|---|
| UE group ID or UE ID | Identifies a UE or a group of UEs, e.g. internal group ID |
| | defined in TS 23.501 [2] clause 5.9.7 or SUPI (see NOTE). |
| UE communications (1 . . . max) | List of communication time slots. |
| (NOTE 1) | |
| >Periodic communication | Identifies whether the UE communicates periodically or not. |
| indicator (NOTE 1) | |
| >Periodic time (NOTE 1) | Interval Time of periodic communication (average and |
| | variance) if periodic. |
| | Example: every hour. |
| >Start time (NOTE 1) | Start time predicted (average and variance). |
| >Duration time (NOTE 1) | Duration interval time of communication. |
| >Traffic characterization | S-NSSAI, DNN, ports, other useful information. |
| >Traffic volume (NOTE 1) | Volume UL/DL (average and variance). |
| >Confidence | Confidence of the prediction. |
| >Ratio | Percentage of UEs in the group (in the case of a UE group). |
| Applications (0 . . . max) (NOTE 1) | List of application in use. |
| >Application Id | Identification of the application. |
| >Start time | Start time of the application. |
| >Duration time | Duration interval time of the application. |
| >Occurrence probability | Probability the application will be used by the UE. |
| >Spatial validity | Area where the service behaviour applies. If Area of Interest |
| | information was provided in the request or subscription, spatial |
| | validity may be a subset of the requested Area of Interest. |
| ATSSS communication | Per SDF which ATSSS rule is applied to |
| >SDF ID | |
| >Ratio of ATSSS | Percentage of traffic volume being steered/switched/split |
| | between 2 access network |
| >Duration | Duration of time which traffic being steered/switch/split |
| | between 2 access network |
| >Latency | Overall average latency |
| >Packet lost rate | Overall PLR |
| >Other QoS/QoE information | |
| N4 Session ID (1 . . . max) | Identification of N4 Session. |
| (NOTE 1) | |
| >Inactivity detection time | Value of session inactivity timer (average and variance). |
| >Confidence | Confidence of the prediction. |

(NOTE 1):
Analytics subset that can be used in “list of analytics subsets that are requested” and “Preferred level of accuracy per analytics subset”.

c. Data Network (DN) Performance analytic: this provides DN Performance Analytics which provides analytics for user plane performance of the Data Network behind N6 interface (i.e. average/maximum traffic rate, average/maximum packet delay, average packet loss rate) in the form of statistics or predictions to a service consumer. An embodiment introduces new input and output analytic information on the DN performance related to ATSSS rules.

An NWDAF can provide DN Performance Analytics which provides analytics for user plane performance (i.e. average/maximum traffic rate, average/maximum packet delay, average packet loss rate) in the form of statistics or predictions to a service consumer. The service consumer may be an NF (e.g. SMF), an AF, a UE or a UPF.

An example of input information is shown in Table 5.

TABLE 5
Performance Data from AF

| Information | Source | Description |
|---|---|---|
| UE identifier | AF | IP address of the UE at the time the |
| | | measurements was made. |
| UE location | AF | The location of the UE when the performance |
| | | measurement was made. |
| Application ID | AF | To identify the service and support analytics |
| | | per type of service (the desired level of |
| | | service). |
| IP filter information | AF | Identify a service flow of the UE for the |
| | | application. |
| Locations of Application | AF/NEF | Locations of application represented by a list |
| | | of DNAI(s). The Network Exposure Function |
| | | (NEF) may map the AF-Service-Identifier |
| | | information to a list of DNAI(s) when the |
| | | DNAI(s) being used by the application are |
| | | statically defined. |
| Application Server Instance | AF/NEF | The IP address/FQDN of the Application |
| address | | Server that the UE had a communication |
| | | session when the measurement was made. |
| ATSSS mode | | |
| >ATSSS rule indication | AF | Indicated if the ATSSS rule is activated for the |
| | | communication session. |
| >ATSSS steer mode | AF | Which steer mode(s) is(are) applied, |
| >Access network type | AF | RAT type |
| >Access network ID | AF | Network ID |
| Performance Data | AF | The performance associated with the |
| | | communication session of the UE with an |
| | | Application Server that includes: Average |
| | | Packet Delay, Average Loss Rate and |
| | | Throughput. |
| Timestamp | AF | A time stamp associated to the Performance |
| | | Data provided by the AF. |

In some embodiments, DN service performance statistics or prediction as an example of output information may refer to Table 6.

TABLE 6
DN service performance statistics or prediction

| Information | Description |
|---|---|
| Application ID | Identifies the application for which analytics |
| | information is provided. |
| S-NSSAI | Identifies the Network Slice for which analytics |
| | information is provided. See note 1. |
| DNN | Identifies the data network name (e.g. “internet”) for |
| | which analytics information is provided. See NOTE 1. |
| DN performance (0-x) | List of DN performances for the application. |
| >Application Server | Identifies the Application Server Instance (IP |
| Instance Address | address/FQDN of the Application Server). |
| >Serving anchor UPF info | The UPF ID/address/FQDN information for the |
| | involved anchor UPF. See NOTE 1. |
| >DNAI | Identifier of a user plane access to one or more DN(s) |
| | where applications are deployed as defined in |
| | TS 23.501 [2]. |
| >ATSSS rule indication | Indicated if the ATSSS rule is activated for the |
| | communication session. |
| >Performance | Performance indicators. |
| >>Average Traffic rate | Average traffic rate observed for UEs communicating |
| (NOTE 2) | with the application. |
| >>Maximum Traffic | Maximum traffic rate observed for UEs communicating |
| rate (NOTE 2) | with the application. |
| >>Average Packet | Average packet delay observed for UEs communicating |
| Delay (NOTE 2) | with the application. |
| >>Maximum Packet | Maximum packet delay for observed for UEs |
| Delay (NOTE 2) | communicating with the application. |
| >>Average Packet Loss | Average packet loss observed for UEs communicating |
| Rate (NOTE 2) | with the application. |
| >>access network | Access network ID associated with the performance if |
| (optional) | the ATSSS rule is activated |
| >>access | Access type associated with the performance if the |
| type(optional) | ATSSS rule is activated |
| >Spatial Validity | Area where the DN performance analytics applies. |
| Condition | |
| >Temporal Validity | Validity period for the DN performance analytics. |
| Condition | |

(NOTE 1):
The item “DNN”, “S-NSSAI” and “Serving anchor UPF info” shall not be included if the consumer NF is an untrusted AF.
(NOTE 2):
Analytics subset that can be used in “list of analytics subsets that are requested”, “Preferred level of accuracy per analytics subset” and “Reporting Thresholds”.

Some Analytic output parameters being defined above in option 2 are common parameters which can be also used in option 1 which the dedicated ATSSS analytic is created.

Some embodiments contain a new implementation option which the Uplink traffic split/steer/switch decision based on the ATSSS rule will be made by the network, so UE only executes the ATSSS instructions from network. The other option is that the UE makes the ATSSS decision for the UL traffic based on the ATSSS rule provided by the network. It's important for UE to have holistic view of system wide performance including network performance to help UE make better steering/switching/splitting decisions. Besides UE can get network side performance information from NWDAF, an embodiment introduces another option allowing the PMF, which may be co-located with the UPF, to provide network measurement information to the UE. The measurement information can be collected by the PMF itself or can be collected information from NWDAF (e.g., this information being defined above) via the PMF. A new network performance container can be introduced in the existing NAS messages being exchanged between the UE and PMF, or other NFs if there is need. All the network measurement information can be conveyed from the network to the UE. This container can also include the communication performance measurement (e.g., DL PLR, UE's DL queue congestion status, so on) which UE measures to help network to make DL decision. That UE measurement can be sent by the UE to the PMF. All the new measurements for ATSSS, as well as the new network performance container which are defined in this application can also be added into the existing Measurement assistance information which is carried in PCC policy being delivered to UE during ATSSS policy provision phase.

Besides the performance measurement information being collected from NWDAF or PMF, another option is also introduced which PMF or UPF can obtain network performance, such as congestion information from the header or masks of some IP protocol, such as UDP, HTTP, or QUIC protocol, from the user plane which those IP packets being transported. This leads to a new measurement type indication being introduced. This indication indicates the source of the measurement, such as from User plane (being measured by PMF with PMF message or decoded from some IP packets) or control plane (from NWDAF) will be sent from the PMF to the NWDAF or other NF or UE which queries the performance information.

As open RAN (O-RAN) is getting more attention as one of 5G implementation and deployment options, new inputs from O-RAN's real time analytic function on measurement for ATSSS rule creation and execution are considered.

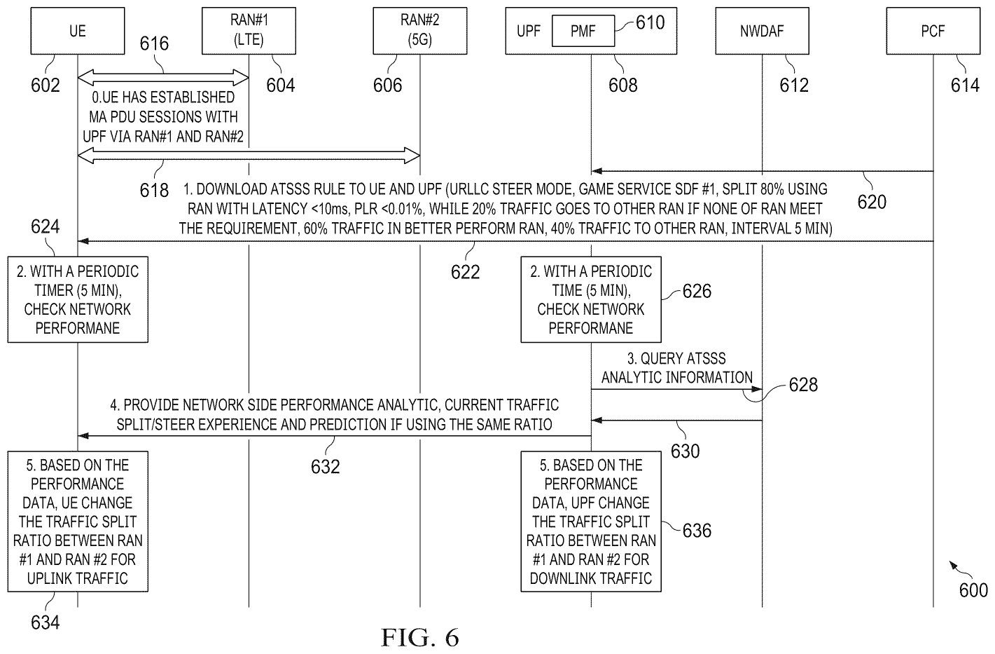

FIG. 6 is a message flow diagram illustrating a method 600 for multi-access and multi-data-path to steer, switch and split URLLC traffic in accordance with a disclosed embodiment. The method 600 shows message flow between a UE 602, a RAN #1 604, a RAN #2 606, a UPF 608, a NWDAF 612, and a PCF 614. The UPF 608 includes a PMF 610. The method 600 begins with the UE 602 establishing a MA PDU session with UPF 608 via RAN #1 604 at step 616 and RAN #2 606 at step 618. Next, at step 620, the UPF downloads the ATSSS rule(s) and, at step 620, the UE 602 downloads the ATSSS rule(s). For example, the ATSSS rules may specify a URLLC steer mode, a game service Service Data Flow (SDF) #1, a split 80% using RAN with latency less than 10 milliseconds (ms), a Packet Loss Rate (PLR) of less than 0.01%, while 20% of traffic goes to other RAN, where if none of the RAN meet the requirement, then 60% traffic goes through better performing RAN 604, 606 and 40% of traffic goes through the other RAN 604, 606, with interval of 5 minutes.

At step 624, the UE 602 checks network performance with a periodic timer of 5 minutes between network performance checks. At step 626, the UPF 608 checks network performance with a periodic timer of 5 minutes between network performance checks. At step 628, the UPF 608 queries the NWDAF 612 for ATSSS analytic information. At step 630, the NWDAF 612 sends network side performance analytic information, current traffic split/steer experience, and prediction if using the same ratio to the UPF 608 and, at step 632, the NWDAF 612 sends network side performance analytic information, current traffic split/steer experience, and prediction if using the same ratio to the UE 602. At step 634, the UE 602 changes the traffic split ratio between the RAN #1 604 and the RAN #2 606 for uplink traffic based on the performance data received from the NWDAF 612 and the ATSSS rule(s). At step 636, the UPF 608 changes the traffic split ratio between the RAN #1 604 and the RAN #2 606 for downlink traffic to the UE 602, after which, the method 600 may end.

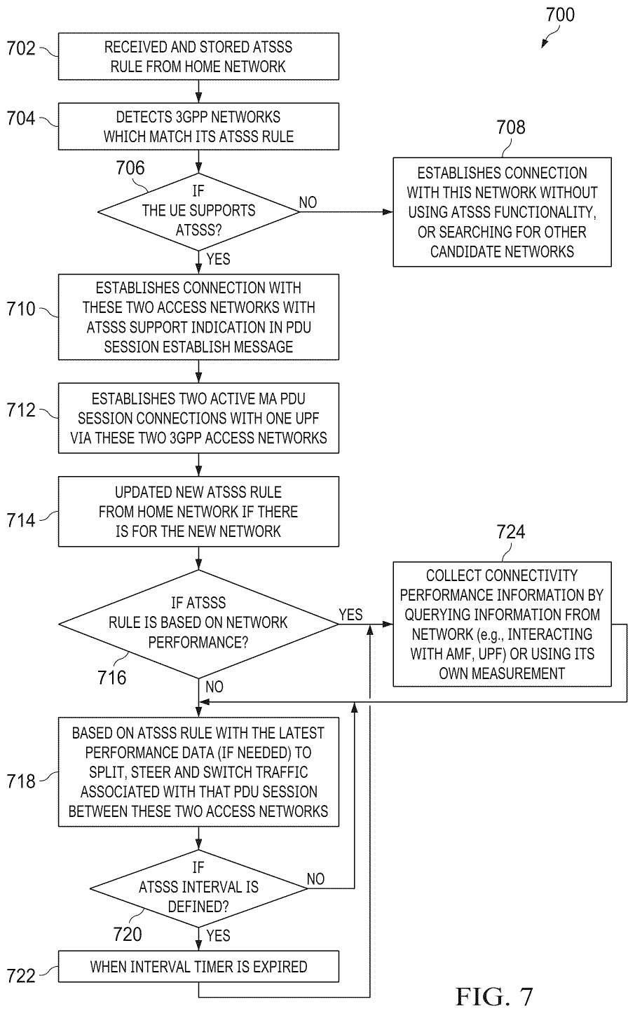

FIG. 7 is a flowchart illustrating an exemplary method 700 in a UE for performing multi access traffic splitting in accordance with a disclosed embodiment. The method 700 begins at step 702 with the UE receiving stored ATSSS rule(s) from the home network. At step 704, the UE detects 3GPP networks which match its ATSSS rule(s). At step 706, the UE determines if the network supports ATSSS. If, at step 706, the UE determines that the network does not support ATSSS, then the method 700 proceeds to step 708 where the UE establishes a connection with the network without using ATSSS functionality or, alternatively, the UE searches for other candidate networks that may support ATSSS functionality, after which, the method 700 may end.

If, at step 706, the UE determines that the network does support ATSSS, the method 700 proceeds to step 710 where the UE establishes connections with the at least two access networks with ATSSS support indication in a PDU session establish message. At step 712, the UE establishes two active MA PDU session connections (links or data paths) with one UPF via these two 3GPP access networks. At step 714, the UE updates the new ATSSS rule(s) from the home network if there is a new ATSSS rule(s) from the new network. At step 716, the UE determines if the ATSSS rule(s) is based on network performance. If, at step 716, the UE determines that the ATSSS rule(s) is not based on network performance, then the method 700 proceeds to step 718 where the UE, based on the ATSSS rule(s) with the latest performance data (if needed), splits, steers, and switches traffic associated with that PDU session between these two access networks. The method 700 then proceeds to step 720 where the UE determines if the ATSSS interval is defined. If, at step 720, the ATSSS interval is not defined, then the method 700 proceeds back to step 718. If, at step 720, the ATSSS interval is defined, then the method 700 proceeds to step 722 where the UE determines when the interval timer has expired, the method 700 proceeds to step 724.

If, at step 716, the UE determines that the ATSSS rule is based on network performance, the method 700 proceeds to step 724. At step 724, either after completing step 722 or after completing step 716, the UE collects connectivity performance information by querying information from the network (e.g., interacting with the AMF, UPF) or using its own measurement, after which, the method 700 proceeds back to step 718.

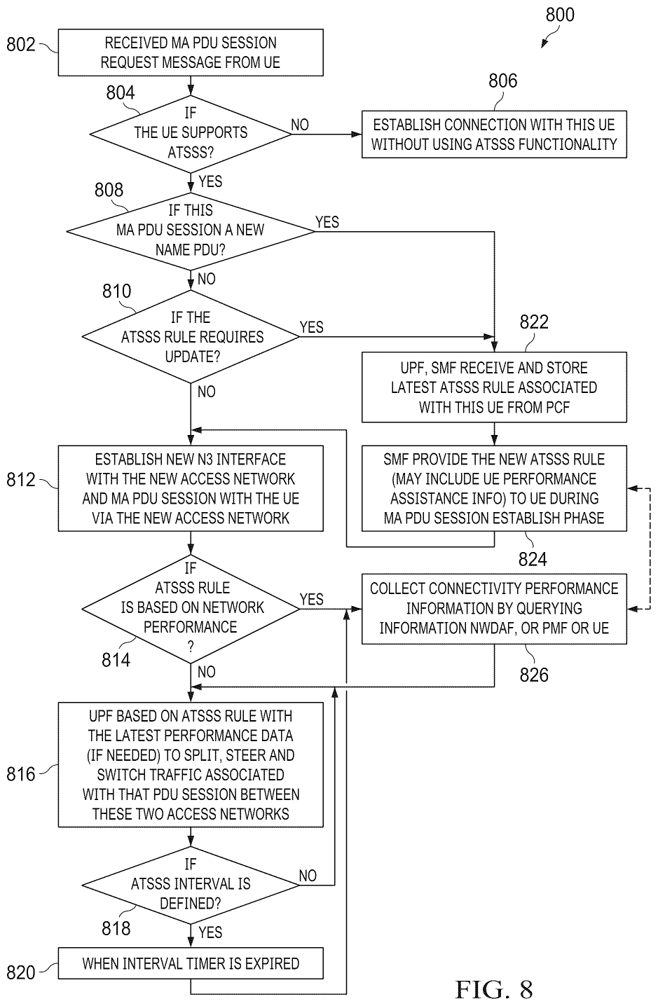

FIG. 8 is a flowchart illustrating an exemplary method 800 in a UPF for performing multi access traffic splitting in accordance with a disclosed embodiment. The method 800 begins at step 802, the UPF receives an MA PDU session request message from a UE. At step 804, the UPF determines if the UE supports ATSSS. If, at step 804, the UPF determines that the UE does not support ATSSS, then the method 800 proceeds to step 806 where the UPF establishes a connection with the UE without using ATSSS functionality, after which, the method 800 may end.

If, at step 804, the UPF determines that the UE does support ATSSS, then the method 800 proceeds to step 808 where the UPF determines if this MA PDU session is a new PDU. If, at step 808, the UPF determines that this MA PDU session is a new session, then the method 800 proceeds to step 822 where the UPF and SMF receive and store the latest ATSSS rule(s) associated with this UE from the PCF. Next, at step 824, the SMF provides the new ATSSS rule(s), which may include UE performance assistance information, to the UE during the MA PDU session establishment phase, after which, the method 800 proceeds to step 812.

If, at step 808, the UPF determines that this MA PDU session is not a new PDU, then the method 800 proceeds to step 810 where the UPF determines if the ATSSS rule(s) requires an update. If, at step 810, the UPF determines that the ATSSS rule(s) requires an update, the method proceeds to step 822 and continues as described above.

If, at step 810, the UPF determines that the ATSSS rule(s) do not require an update, then the method 800 proceeds to step 812 wherein the UPF establishes a new N3 interface with the new access network and MA PDU session with the UE via the new access network. Next, the method 800 proceeds to step 814 where the UPF determines if the ATSSS rule is based on network performance and, if yes, the method 800 proceeds to step 826, where the UPF collects connectivity performance information by querying information from the NWDAF, from the PMF, or from the UE, after which the method 800 proceeds to step 816. If, at step 814, the UPF determines that the ATSSS rule is not based on network performance, then the method proceeds to step 816. At step 816, the UPF, splits, steers, and switches traffic associated with the PDU session between these two access networks based on the ATSSS rule(s) and on the latest performance data (if needed). The method 800 then proceeds to step 818 wherein the UPF determines if the ATSSS interval is defined, and, if not, the method 800 proceeds back to step 816. If, at step 818, the UPF determines that the ATSSS interval is defined, then the method 800 proceeds to step 820, where the UPF determines when the interval timer is expired and after expiration of the timer, the method 800 proceeds to step 826 and proceeds as described above.

An aspect of the disclosure provides a method in which a UPF establishes a MA PDU session with a UE via a first network and a second network. The UPF device or related user plane management function (e.g., SMF) device may receive an ATSSS rule, send an ATSSS query responsive to a re-evaluation of a network performance against the ATSSS rule to a NWDAF device, receive experience and prediction data from the NWDAF device, and forward the experience and prediction data to the UE.

The first network and the second network may be a first RAN and a second RAN. For example, the first network may be an LTE RAN and the second network may be a 5G RAN. The first network may be a Terrestrial Network RAN, and the second network may be a Non-Terrestrial Network RAN. The first network may belong to a first operator, and the second network may belong to a second operator.

The ATSSS rule may indicate information on how to split/steer/switch traffic between the first network and the second network for the UE and the MA PDU session.

The UPF device may forward the experience and prediction data in a network performance container via a message exchange between the UE and a PMF of the UPF device.

The related user plane management function may forward the performance experience and prediction data to the UE devices using other network management message via a control plane between UE and the network function.

The re-evaluation is performed by the UPF device and the UE after a timer expiration.

The UPF device may receive the ATSSS rule from a PCF device, and the UPF device or other network functions forwards the ATSSS rule to the UE.

Another aspect of the disclosure provides a method in which a network function node may receive an ATSSS policy that defines information as how to steer, switch, and split traffic between two data paths going through two or more different 3GPP RATs, two or more different 3GPP networks, or two or more different types of 3GPP networks concurrently, send the ATSSS policy to a UE and a second network function node. The second network function node may query a third network function node on performance data related to the ATSSS policy and execute, according to a defined period, based on the received ATSSS policy, to steer, switch, and split downlink traffic to different data paths going through the two or more different 3GPP RATs or the two or more different types of 3GPP networks.

The first network function node may be a PCF node, and the second network function node may be a UPF node or an SMF node, wherein the third network function node may be a NWDAF node.

The two or more different 3GPP RATs may comprise 4G, 5G, NTN including different satellite RANs (GEO or LEO satellite), where two or more different types of 3GPP networks include a public network or a private network.

Another aspect of the disclosure provides a method performed by a UE. The UE may connect to a first network for a first data path, wherein the first network comprises a first 3GPP RAT (4G, 5G, NTN), a first 3GPP network type, or a 3GPP network ID, and connect to a second network for a second data path, wherein the second network comprises a second 3GPP RAT (4G, 5G, NTN), a second 3GPP network type, or a second 3GPP network ID. The UE may receive, from a first network function (e.g., AMF) node, an ATSSS policy which defines information as how to steer, switch, and split traffic between the first data path and the second data path. The UE may query or receive from a second network function (e.g., UPF) node on performance data which is related to the ATSSS policy, and execute, according to a defined period, based on the received ATSSS policy, to steer, switch, and split uplink traffic to different data paths going through different 3GPP RATs or different type of 3GPP networks. two data paths going through two or more different 3GPP RATs (4G, 5G, NTN), two or more different 3GPP networks, or two or more different types of 3GPP networks (public or private network) concurrently.

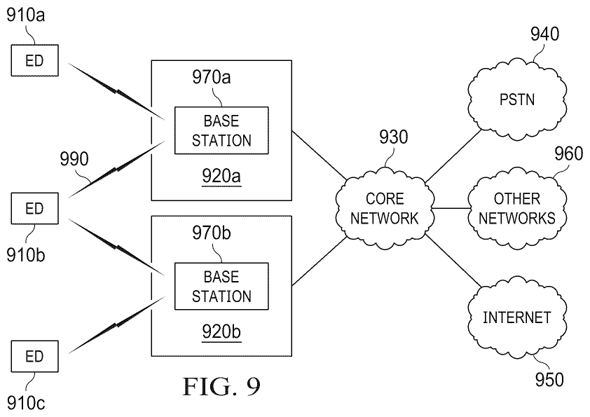

FIG. 9 illustrates an example communication system 900. In general, the system 900 enables multiple wireless or wired users to transmit and receive data and other content. The system 900 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 900 includes electronic devices (ED) 910a-510c, radio access networks (RANs) 920a-520b, a core network 930, a public switched telephone network (PSTN) 940, the Internet 950, and other networks 960. While certain numbers of these components or elements are shown in FIG. 9, any number of these components or elements may be included in the system 900.

The EDs 910a-510c are configured to operate or communicate in the system 900. For example, the EDs 910a-510c are configured to transmit or receive via wireless or wired communication channels. Each ED 910a-510c represents any suitable end user device and may include such devices (or may be referred to) as a UE or user device, wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 920a-520b here include base stations 970a-570b, respectively. Each base station 970a-570b is configured to wirelessly interface with one or more of the EDs 910a-510c to enable access to the core network 930, the PSTN 940, the Internet 950, or the other networks 960. For example, the base stations 970a-570b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 910a-510c are configured to interface and communicate with the Internet 950 and may access the core network 930, the PSTN 940, or the other networks 960.

In the embodiment shown in FIG. 9, the base station 970a forms part of the RAN 920a, which may include other base stations, elements, or devices. Also, the base station 970b forms part of the RAN 920b, which may include other base stations, elements, or devices. Each base station 970a-570b operates to transmit or receive wireless signals within a particular geographic region or area, sometimes referred to as a “cell.” In some embodiments, multiple-input multiple-output (MIMO) technology may be employed having multiple transceivers for each cell.

The base stations 970a-570b communicate with one or more of the EDs 910a-510c over one or more air interfaces 990 using wireless communication links. The air interfaces 990 may utilize any suitable radio access technology.

It is contemplated that the system 900 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 920a-520b are in communication with the core network 930 to provide the EDs 910a-510c with voice, data, application, Voice over Internet Protocol (VoIP), or other services. Understandably, the RANs 920a-520b or the core network 930 may be in direct or indirect communication with one or more other RANs (not shown). The core network 930 may also serve as a gateway access for other networks (such as the PSTN 940, the Internet 950, and the other networks 960). In addition, some or all of the EDs 910a-510c may include functionality for communicating with different wireless networks over different wireless links using different wireless technologies or protocols. Instead of wireless communication (or in addition thereto), the EDs may communicate via wired communication channels to a service provider or switch (not shown), and to the Internet 950.

Although FIG. 9 illustrates one example of a communication system, various changes may be made to FIG. 9. For example, the communication system 900 could include any number of EDs, base stations, networks, or other components in any suitable configuration.

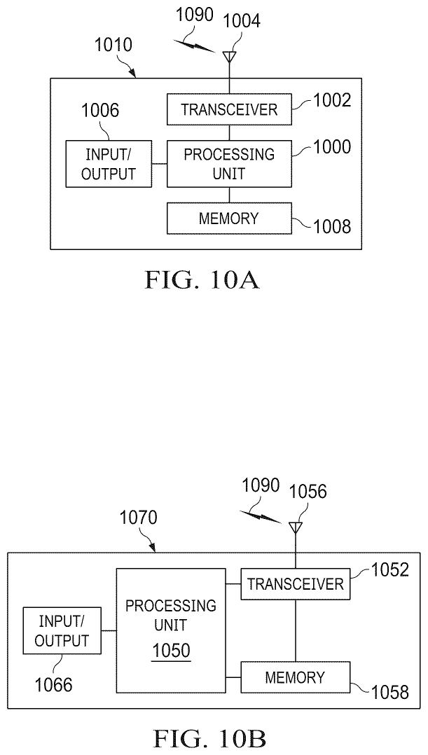

FIGS. 10A and 10B illustrate example devices that may implement the methods and teachings according to this disclosure. In particular, FIG. 10A illustrates an example ED 1010, and FIG. 10B illustrates an example base station 1070. These components could be used in the system 900 or in any other suitable system.

As shown in FIG. 10A, the ED 1010 includes at least one processing unit 1000. The processing unit 1000 implements various processing operations of the ED 1010. For example, the processing unit 1000 could perform signal coding, data processing, power control, input/output processing, or any other functionality enabling the ED 1010 to operate in the system 1000. The processing unit 1000 also supports the methods and teachings described in more detail above. Each processing unit 1000 includes any suitable processing or computing device configured to perform one or more operations. Each processing unit 1000 could, for example, include a microprocessor, microcontroller, digital signal processor, field programmable gate array, or application specific integrated circuit.

The ED 1010 also includes at least one transceiver 1002. The transceiver 1002 is configured to modulate data or other content for transmission by at least one antenna or NIC (Network Interface Controller) 1004. The transceiver 1002 is also configured to demodulate data or other content received by the at least one antenna 1004. Each transceiver 1002 includes any suitable structure for generating signals for wireless or wired transmission or processing signals received wirelessly or by wire. Each antenna 1004 includes any suitable structure for transmitting or receiving wireless or wired signals. One or multiple transceivers 1002 could be used in the ED 1010, and one or multiple antennas 1004 could be used in the ED 1010. Although shown as a single functional unit, a transceiver 1002 could also be implemented using at least one transmitter and at least one separate receiver.

The ED 1010 further includes one or more input/output devices 1006 or interfaces (such as a wired interface to the Internet 950). The input/output devices 1006 facilitate interaction with a user or other devices (network communications) in the network. Each input/output device 1006 includes any suitable structure for providing information to or receiving information from a user, such as a speaker, microphone, keypad, keyboard, display, or touch screen, including network interface communications.

In addition, the ED 1010 includes at least one memory 1008. The memory 1008 stores instructions and data used, generated, or collected by the ED 1010. For example, the memory 1008 could store software or firmware instructions executed by the processing unit(s) 1000 and data used to reduce or eliminate interference in incoming signals. Each memory 1008 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 10B, the base station 1070 includes at least one processing unit 1050, at least one transceiver 1052, which includes functionality for a transmitter and a receiver, one or more antennas 1056, at least one memory 1058, and one or more input/output devices or interfaces 1066. A scheduler, which would be understood by one skilled in the art, is coupled to the processing unit 1050. The scheduler could be included within or operated separately from the base station 1070. The processing unit 1050 implements various processing operations of the base station 1070, such as signal coding, data processing, power control, input/output processing, or any other functionality. The processing unit 1050 can also support the methods and teachings described in more detail above. Each processing unit 1050 includes any suitable processing or computing device configured to perform one or more operations. Each processing unit 1050 could, for example, include a microprocessor, microcontroller, digital signal processor, field programmable gate array, or application specific integrated circuit.

Each transceiver 1052 includes any suitable structure for generating signals for wireless or wired transmission to one or more EDs or other devices. Each transceiver 1052 further includes any suitable structure for processing signals received wirelessly or by wire from one or more EDs or other devices. Although shown combined as a transceiver 1052, a transmitter and a receiver could be separate components. Each antenna 1056 includes any suitable structure for transmitting or receiving wireless or wired signals. While a common antenna 1056 is shown here as being coupled to the transceiver 1052, one or more antennas 1056 could be coupled to the transceiver(s) 1052, allowing separate antennas 1056 to be coupled to the transmitter and the receiver if equipped as separate components. Each memory 1058 includes any suitable volatile or non-volatile storage and retrieval device(s). Each input/output device 1066 facilitates interaction with a user or other devices (network communications) in the network. Each input/output device 1066 includes any suitable structure for providing information to or receiving/providing information from a user, including network interface communications.

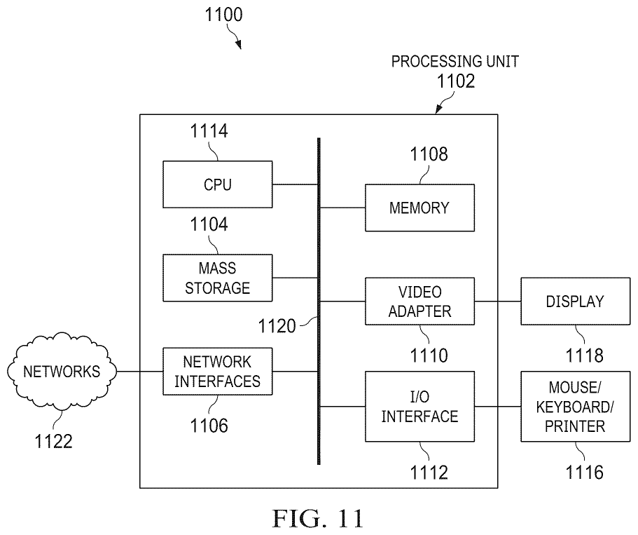

FIG. 11 is a block diagram of a computing system 1100 that may be used for implementing the devices and methods disclosed herein, according to some embodiments. For example, the computing system may be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1100 includes a processing unit 1102. The processing unit includes a central processing unit (CPU) 1114, memory 1108, and may further include a mass storage device 1104, a video adapter 1110, and an I/O interface 1112 connected to a bus 1120.

The bus 1120 may be one or more of any type of several bus architectures including a memory bus or memory controller, a peripheral bus, or a video bus. The CPU 1114 may comprise any type of electronic data processor. The memory 1108 may comprise any type of non-transitory system memory such as static random access memory (SRAM), dynamic random access memory (DRAM), synchronous DRAM (SDRAM), read-only memory (ROM), or a combination thereof. In an embodiment, the memory 1108 may include ROM for use at boot-up, and DRAM for program and data storage for use while executing programs.

The mass storage 1104 may comprise any type of non-transitory storage device configured to store data, programs, and other information and to make the data, programs, and other information accessible via the bus 1120. The mass storage 1104 may comprise, for example, one or more of a solid state drive, hard disk drive, a magnetic disk drive, or an optical disk drive.

The video adapter 1110 and the I/O interface 1112 provide interfaces to couple external input and output devices to the processing unit 1102. As illustrated, examples of input and output devices include a display 1118 coupled to the video adapter 1110 and a mouse, keyboard, or printer 1116 coupled to the I/O interface 1112. Other devices may be coupled to the processing unit 1102, and additional or fewer interface cards may be utilized. For example, a serial interface such as Universal Serial Bus (USB) (not shown) may be used to provide an interface for an external device.

The processing unit 1102 also includes one or more network interfaces 1106, which may comprise wired links, such as an Ethernet cable, or wireless links to access nodes or different networks. The network interfaces 1106 allow the processing unit 1102 to communicate with remote units via the networks. For example, the network interfaces 1106 may provide wireless communication via one or more transmitters/transmit antennas and one or more receivers/receive antennas. In an embodiment, the processing unit 1102 is coupled to a local-area network 1122 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a querying unit/module, a steering unit/module, a switching unit/module, and/or a splitting unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations may be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method for access traffic controlling, comprising:
receiving, by a first network function device from a second network function device, an access traffic rule for a multi-access protocol data unit (MA PDU) session of a user equipment (UE), wherein the access traffic rule defines information on how to handle a traffic flow associated with the MA PDU session over multiple data paths corresponding to different access networks;
receiving, by the first network function device from a third network function device, network performance data related to the access traffic rule; and
performing, by the first network function device, access traffic controlling of the traffic flow over the multiple data paths in accordance with the access traffic rule and the network performance data.

2. The method of claim 1, wherein the access traffic rule is an access traffic steering, switching, and splitting (ATSSS) rule.

3. The method of claim 1, wherein the first network function device is a user plane function (UPF) device, the second network function device is a policy configuration function (PCF) device or a home network device, and the third network function device is a network data analytic function (NWDAF) device.

4. The method of claim 2, wherein the ATSSS rule comprises ATSSS rule timer information indicating a periodic interval which the ATSSS rule needs to be checked and executed; and the method further comprises:
setting, by the first network function device, an ATSSS rule timer in accordance with the ATSSS rule timer information.

5. The method of claim 2, wherein the ATSSS rule comprises at least one of:
access type information indicating an access type of an access network,
network type information indicating a network type of a network to which the ATSSS rule will be applied, or
network identifier information indicating an identifier of a network associated with the ATSSS rule.

6. The method of claim 2, further comprising:
sending, by the first network function device to the UE, an ATSSS indication indicating an ATSSS capability supported by at least one of the different access networks.

7. The method of claim 2, wherein the ATSSS rule comprises at least one of a dual access connectivity time restriction or a dual access connectivity location restriction.

8. The method of claim 2, wherein the ATSSS rule comprises at least one of:
a location-based steer mode in which a traffic controlling decision is made based on a location of the UE or based on a predicted UE location;
a time-based steer mode in which different traffic control rules are provided for use based on different time windows;
a customized-performance-based steer mode in which a traffic controlling decision is made based on a home operator who owns a subscription of the UE, can define its own performance criteria defined by the home operator; or
an ultra reliable low latency communication (URLLC) steer mode for URLLC traffic in which a traffic controlling decision is made based on a performance metric of combining a delay and a reliability.

9. The method of claim 1, the method further comprising:
obtaining, by the first network function device, at least one of statistics information or prediction information; and
sending, by the first network function device to the UE, the at least one of: the statistics information or the prediction information for UE uplink traffic controlling over the multiple data paths corresponding to the different access networks.

10. A method performed by a user equipment (UE), comprising:
establishing, by the UE, a multi-access protocol data unit (MA PDU) session with a first network function device over multiple data paths corresponding to different access networks;
receiving, by the UE from a second network function device, an access traffic rule that defines information on how to handle a traffic flow for the MA PDU session over the multiple data paths corresponding to the different access networks;
receiving, by the UE, performance data related to the access traffic rule; and
transmitting, by the UE, traffic data of the traffic flow over the multiple data paths in accordance with the access traffic rule and the performance data.

11. The method of claim 10, wherein the access traffic rule is an access traffic steering, switching, and splitting (ATSSS) rule.

12. The method of claim 10, wherein the first network function device is a user plane function (UPF) device, the second network function device is a policy configuration function (PCF) device or a home network device.

13. The method of claim 11, wherein the ATSSS rule comprises ATSSS rule timer information indicating a periodic interval which the ATSSS rule needs to be checked and executed, and the method further comprises:
setting, by the UE, an ATSSS rule timer in accordance with the ATSSS rule timer information.

14. The method of claim 11, wherein the ATSSS rule comprises at least one of:
access type information indicating an access type of an access network,
network type information indicating a network type of a network to which the ATSSS rule will be applied, or
network identifier information indicating an identifier of a network associated with the ATSSS rule.

15. The method of claim 11, further comprising:
receiving, by the UE, an ATSSS indication indicating an ATSSS capability supported by at least one of the different access networks.

16. The method of claim 11, wherein the ATSSS rule comprises at least one of a dual access connectivity time restriction or a dual access connectivity location restriction.

17. The method of claim 11, wherein the ATSSS rule comprises at least one of:
a location-based steer mode in which a traffic controlling decision is made based on a location of the UE or based on a predicted UE location;
a time-based steer mode in which different traffic control rules are provided for use based on different time windows;
a customized-performance-based steer mode in which a traffic controlling decision is made based on a home operator who owns a subscription of the UE, can define its own performance criteria defined by the home operator; or
an ultra reliable low latency communication (URLLC) steer mode for URLLC traffic in which a traffic controlling decision is made based on a performance metric of combining a delay and a reliability.

18. The method of claim 10, the method further comprising:
receiving, by the UE, at least one of statistics information or prediction information used for controlling the traffic flow over the multiple data paths corresponding to different access networks.

19. An apparatus, comprising:
at least one processor; and
a non-transitory memory storing programming instructions that, when executed by the at least one processor, cause the apparatus to perform operations including:
receiving, from a second network function device, an access traffic rule for a multi-access protocol data unit (MA PDU) session of a user equipment (UE), wherein the access traffic rule defines information on how to handle a traffic flow associated with the MA PDU session over multiple data paths corresponding to different access networks;
receiving, from a third network function device, network performance data related to the access traffic rule; and
performing access traffic controlling of the traffic flow over the multiple data paths in accordance with the access traffic rule and the network performance data.

20. An apparatus, comprising:
at least one processor; and
a non-transitory memory storing programming instructions that, when executed by the at least one processor, cause the apparatus to perform operations including:
establishing a multi-access protocol data unit (MA PDU) session with a first network function device over multiple data paths corresponding to different access networks;
receiving, from a second network function device, an access traffic rule that defines information on how to handle a traffic flow for the MA PDU session over the multiple data paths corresponding to the different access networks;
receiving performance data related to the access traffic rule; and
transmitting traffic data of the traffic flow over the multiple data paths in accordance with the access traffic rule and the performance data.
